(19) United States
(12) Patent Application Publication
(10) Pub. No.: US 2018/0042025 A1
(43) Pub. Date: Feb. 8, 2018

(54) REFERENCE SIGNAL PATTERN DETECTION IN WIRELESS TRANSMISSIONS

(71) Applicant: QUALCOMM Incorporated, San Diego, CA (US)

(72) Inventors: Guttorm OPSHAUG, Redwood City, CA (US); Ju-Yong DO, Cupertino, CA (US); Mariam MOTAMED, Redwood City, CA (US)

(21) Appl. No.: 15/227,508

(22) Filed: Aug. 3, 2016

(51) Int. Cl. H04W 72/08; H04L 5/00

(52) U.S. Cl. CPC H04W 72/08; H04L 5/0051

(57) ABSTRACT

Disclosed are implementations that include a method, generally performed at a mobile device, including receiving one or more wireless signals transmitted from a wireless node, with the wireless node being configured to operate in at least a first mode of operation to transmit wireless transmissions comprising one or more subframes configured according to a pre-determined first pattern of cell-specific reference signals (CRS) for the wireless node. The method also includes deriving, based on the received one or more wireless signals, at least one resultant signal attribute indicative of an actual CRS pattern for the received one or more wireless signals, and determining whether the at least one resultant signal attribute derived based on the received one or more wireless signals deviates from a corresponding expected at least one signal attribute associated with wireless signals including cell-specific reference signals produced according to the pre-determined first pattern of CRS.

### BACKGROUND

Wireless transmissions from wireless nodes (e.g., base stations, such as eNBs) can be configured as frame-based transmissions that include reference signals (e.g., cell-specific reference signals, positioning reference signals, etc.) that aide control and detection operations performed by receiving mobile stations. For example, reference signals can be included in downlink LTE transmissions according to some pre-determined pattern. The wireless signals received by the mobile device provide data content (to facilitate voice and data operations) and also to facilitate positioning functionality.

### SUMMARY

In some variations, an example method is provided. The method includes receiving, at a mobile device, one or more wireless signals transmitted from a wireless node, with the wireless node being configured to operate in at least a first mode of operation to transmit wireless transmissions comprising one or more subframes configured according to a pre-determined first pattern of cell-specific reference signals (CRS) for the wireless node. The method also includes deriving, at the mobile device, based on the received one or more wireless signals, at least one resultant signal attribute indicative of an actual CRS pattern for the received one or more wireless signals, and determining, at the mobile device, whether the at least one resultant signal attribute derived based on the received one or more wireless signals deviates from a corresponding expected at least one signal attribute associated with wireless signals including cell-specific reference signals produced according to the pre-determined first pattern of CRS.

Embodiments of the method may include at least some of the features described in the present disclosure, including one or more of the following features.

The method may further include transmitting by the mobile device to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS.

The method may further include receiving from a remote device, maintaining assistance data relating to one or more wireless nodes, a message comprising information indicative of one or more modes of operation for the wireless node, each of the one or more modes of operation associated with a different one of one or more CRS patterns for respective one or more wireless transmissions from the wireless node.

The wireless node may be an evolved node B (eNB), and the wireless transmissions from the wireless node may be configured as long term evolution (LTE) transmissions.

Deriving the at least one resultant signal attribute may include determining a channel energy response (CER) function based on the received one or more wireless signals, and deriving the at least one resultant signal attribute based on the determined CER function.

Determining the CER function may include transforming the received one or more wireless signals into a frequency domain representation comprising frequency vectors, performing frequency-domain processing, including multiplying the frequency vectors with one or more pre-determined scrambling codes, to derive resultant frequency vectors, and transforming the resultant frequency vectors to obtain a resultant time-domain CER function output.

Deriving the at least one resultant signal attribute may include determining a non-linear function approximation for a maximum peak of the determined CER function, and setting the at least one resultant signal attribute to at least one parameter representative of the non-linear function approximation for the maximum peak of the determined CER function.

The non-linear function approximation for the maximum peak of the determined CER function may be a quadratic expression.

Deriving the at least one resultant signal attribute may include determining a period between peaks of the CER function, the period between the peaks being indicative of the actual CRS pattern for the received one or more wireless signals.

Receiving the one or more wireless signals transmitted from the wireless node may include receiving the one or more wireless signals using multiple different timing attributes applied to the received one or more wireless signals.

The multiple different timing attributes applied to the one or more received wireless signals may include, for example, offset attributes representative of relative starting positions of a CRS signal from a beginning of a first subframe, and/or repetition attributes representative of repetition period of CRS signals in the received one or more wireless signals.

The wireless node may be configured according to one of multiple possible deployments corresponding to respective multiple possible bandwidths, with each of the multiple possible deployments being associated with a respective at least the first mode of operation controlling a respective number of resource blocks in every subframe of the one or more wireless signals comprising cell-specific reference signals.

In some variations, a mobile wireless device is provided that includes a transceiver configured to receive one or more wireless signals transmitted from a wireless node, with the wireless node being configured to operate in at least a first mode of operation to transmit wireless transmissions comprising one or more subframes configured according to a pre-determined first pattern of cell-specific reference signals (CRS) for the wireless node. The mobile device also includes one or more processors, coupled to the transceiver, configured to derive, based on the received one or more wireless signals, at least one resultant signal attribute indicative of an actual CRS pattern for the received one or more wireless signals, and determine whether the at least one resultant signal attribute derived based on the received one or more wireless signals deviates from a corresponding expected at least one signal attribute associated with wireless signals including cell-specific reference signals produced according to the pre-determined first pattern of CRS.

In some variations, an apparatus is provided that includes means for receiving, at a mobile device, one or more wireless signals transmitted from a wireless node, with the wireless node being configured to operate in at least a first mode of operation to transmit wireless transmissions comprising one or more subframes configured according to a pre-determined first pattern of cell-specific reference signals (CRS) for the wireless node. The apparatus also includes means for deriving, based on the received one or more wireless signals, at least one resultant signal attribute indicative of an actual CRS pattern for the received one or more wireless signals, and means for determining whether the at least one resultant signal attribute derived based on the received one or more wireless signals deviates from a corresponding expected at least one signal attribute associated with wireless signals including cell-specific reference signals produced according to the pre-determined first pattern of CRS.

In some variations, a non-transitory computer-readable media is provided, that is programmed with instructions, executable on a processor, to receive, at a mobile device, one or more wireless signals transmitted from a wireless node, with the wireless node being configured to operate in at least a first mode of operation to transmit wireless transmissions comprising one or more subframes configured according to a pre-determined first pattern of cell-specific reference signals (CRS) for the wireless node. The computer-readable media is also programmed with instructions to derive, at the mobile device, based on the received one or more wireless signals, at least one resultant signal attribute indicative of an actual CRS pattern for the received one or more wireless signals, and determine, at the mobile device, whether the at least one resultant signal attribute derived based on the received one or more wireless signals deviates from a corresponding expected at least one signal attribute associated with wireless signals including cell-specific reference signals produced according to the pre-determined first pattern of CRS.

Embodiments of the mobile device, the apparatus, and the computer-readable media may include at least some of the features described in the present disclosure, including at least some of the features described above in relation to the method.

Other and further objects, features, aspects, and advantages of the present disclosure will become better understood with the following detailed description of the accompanying drawings.

### BRIEF DESCRIPTION OF THE DRAWINGS

FIG. 1 is a schematic diagram of an example operating environment that includes a wireless mobile device in communication with one or more wireless nodes / devices.

FIG. 2 is a flowchart of an example procedure to detect modes of operation for a wireless node.

FIG. 3 is a diagram of an example frame structure for downlink transmission in LTE.

FIG. 4 is a diagram of two example subframe configurations for LTE downlink transmissions.

FIG. 5 is a graph showing alias terms for a CER function generated from received LTE wireless transmissions configured according to a mixed-bandwidth mode of operation.

FIG. 6 is a flowchart of an example procedure, generally performed at a server, to collect and manage mode-of-operation information for one or more wireless nodes.

FIG. 7 is a schematic diagram of an example wireless device (e.g., UE).

FIG. 8 is a schematic diagram of an example node (e.g., a base station, an access point, a server, etc.).

FIG. 9 is a schematic diagram of an example computing system.

Like reference symbols in the various drawings indicate like elements, in accordance with certain example implementations.

### DETAILED DESCRIPTION

Described are implementations to detect modes of operation of a wireless node (e.g., a base station, such as an eNB node) based on a single set of measurements applied to wireless signals (that include a cell-specific reference signals pattern), transmitted from the wireless node. The set of measurement is used to derive at least one signal attribute for the received signals, which is indicative of an actual cell-specific reference signal pattern. That derived at least one signal attribute can be compared to an expected signal attribute corresponding to a known CRS pattern the wireless node may include in wireless transmission. A deviation of the derived signal attribute from the expected signal attribute may indicate that the wireless node can transmit wireless signals configured using a different CRS pattern from its expected pattern, and may thus indicate that the wireless node is configured to operate in a mode in which a different CRS pattern (e.g., a narrow band of CRS signals) is used. The mobile device can then be configured to operate, within that cell, for the possible additional mode of operation of the wireless node. If the mobile device detects the possibility of one or more additional modes of operation for the wireless node serving the cell, assistance data (maintained at some remote server, and distributed to multiple wireless devices) can be updated to indicate that the base station that transmitted the wireless transmissions is capable of more than one mode of operation.

Thus, in some embodiments, a method is provided that includes receiving, at a mobile device, one or more wireless signals transmitted from a wireless node, with the wireless node being configured to operate in at least a first mode of operation (e.g., full CRS bandwidth) to transmit wireless transmissions comprising one or more subframes configured according to a pre-determined first pattern of cell-specific reference signals (CRS) for the wireless node. The method further includes deriving, at the mobile device, based on the received one or more wireless signals, at least one resultant signal attribute indicative of an actual CRS pattern for the received one or more wireless signals, and determining, at the mobile device, whether the at least one resultant signal attribute derived based on the received one or more wireless signals deviates from a corresponding expected at least one signal attribute associated with wireless signals including cell-specific reference signals produced according to the pre-determined first pattern of CRS. In some embodiments, the at least one signal attribute may include one or more of, for example, a maximum peak of a channel energy response (CER) function (also referred to as a correlation function) determined from the received one or more wireless signals, a period between peaks of such a determined CER function, etc. In some embodiments, the method may further include transmitting by the mobile device to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS.

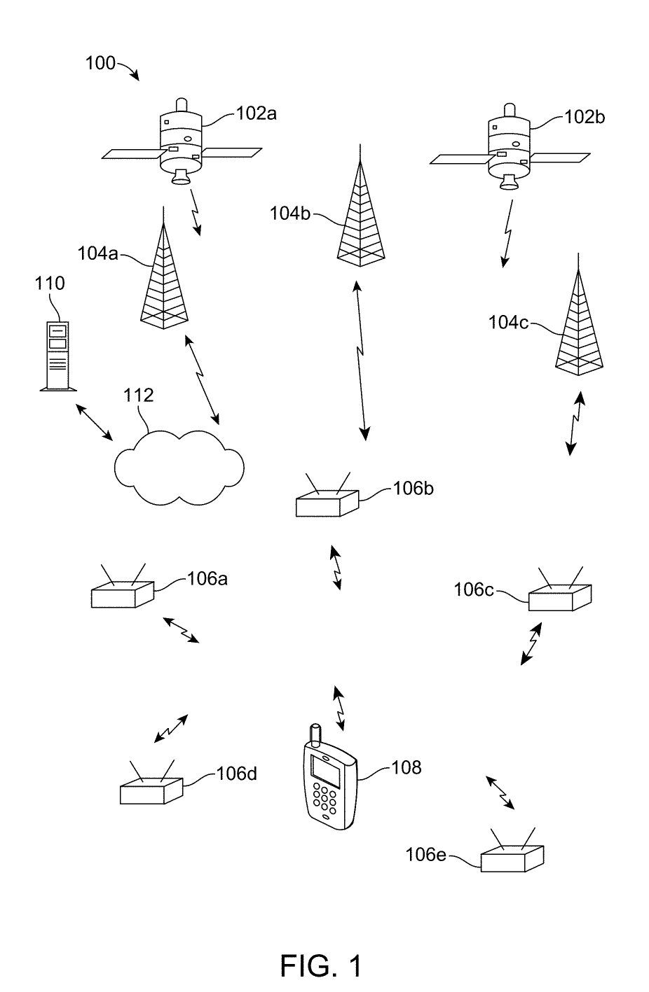

With reference now to FIG. 1, a schematic diagram of an example operating environment 100 that includes a wireless mobile device (also referred to as a UE or as a mobile station) 108 in communication with one or more wireless nodes or devices. The various wireless nodes/devices of FIG. 1 may be configured to communicate according to one or more communication protocols. In some embodiments, the various wireless devices of FIG. 1, including, the mobile device 108 and the wireless nodes may be configured to implement location determination techniques and processes, such as techniques and processes based on timing and signal detection, e.g., observed time difference of arrival (OTDOA) positioning determination process.

In some embodiments, one or more of the wireless nodes may be an evolved node B (eNB) configured to transmit transmissions configured as long term evolution (LTE) transmissions. In such embodiments, the one or more wireless nodes configured as eNB nodes may transmit wireless signals arranged as subframes that include control signals and actual data content, with the control signaling including references signals that include cell-specific reference signals (CRS), positioning reference signals (PRS), etc. Positioning reference signals, which have been defined (e.g., in relation to base station (eNB) transmissions) in 3GPP Long Term Evolution (LTE) Release-9, are transmitted (e.g., by a node such as a base station) in special positioning sub-frames that are grouped into positioning occasions. For example, in LTE, the positioning occasion, N_{PRS} can include 1, 2, 4, or 6 consecutive positioning sub-frames and occurs periodically at, for example, 160, 320, 640, or 1280 millisecond intervals. The positioning occasions recur with some pre-determined PRS periodicity denoted T_{PRS}. In some embodiments, T_{PRS} may be measured in terms of the number of sub-frames between the start of consecutive positioning occasions.

With continued reference to FIG. 1, the mobile device 108 (as well as any other device depicted in FIG. 1) may be configured to operate and interact with multiple types of other communication systems/devices, including local area network devices (or nodes), such as WLAN for indoor communication, femtocells, Bluetooth® wireless technology-based transceivers, and other types of indoor communication network nodes, wide area wireless network nodes (e.g., base stations, evolved NodeBs (eNBs), etc., satellite communication systems, other mobile devices, etc., and as such the mobile device 108 may include one or more interfaces to communicate with the various types of communications systems. The various devices of FIG. 1 may be configured to establish and operate according to any number of communication protocols, including, for example, a long-term evolution positioning protocol (LPP) in which a location server, which may include a wireless communication module (e.g., a wireless transceiver), or which may be in communication with a wireless device, facilitates location determination for a first device (such as the mobile device 108).

As noted, the mobile wireless device 108 may be configured to implement location determination operations (e.g., based on OTDOA), and may thus be configured to measure signals from reference sources (such as any of the nodes 104a-c, and/or106a-e) to determine location estimate(s). The mobile device 108 may, in some embodiments, obtain measurements by measuring pseudo-range measurements for satellite vehicles, such as the vehicles 102a-b depicted in FIG. 1 and/or OTDOA related measurements from antennas of the various terrestrial (i.e., ground-based nodes). In some embodiments, the OTDOA related measurements taken by the mobile device 108 may be sent to a server, such as a server 110, to derive a position estimate for the mobile device 108. For example, the mobile device 108 may provide location related information, such as location estimates or measurements (e.g., satellite measurements from one or more GNSS, or various network measurements such as RSTDs from one or more network nodes, etc.) to the server 110. In some instances, the mobile device 108 may also obtain a location estimate by using measurements from various nodes transmitting signals, which may be pseudo-range and/or OTDOA related measurements, to derive an estimated position for the mobile device 108. The mobile device 108 may use the difference in the arrival times of downlink radio signals from a plurality of base stations (such as eNB nodes, etc.) to compute the user's/mobile device's position. For example, if a signal from one cell (e.g., served by one of the base stations depicted in FIG. 1) is received at time t₁, and a signal from another cell is received at time t₂, then the OTDOA or RSTD is given by t₂-t₁. Generally, t₂ and t₁ are known as time-of-arrival (TOA) measurements. In some embodiments, the mobile device 108 may take the form of a Secure User Plane (SUPL) Enabled Terminal (SET) and may communicate with a server (such as the server 110) and use location assistance data (e.g., provided by a location server via, for example, eNB) to obtain a location estimate for the mobile device 108, which may then be communicated to, for example, some other device.

In some embodiments, the mobile device 108 may be configured to detect a mode of operation of the node(s) from which it receives wireless transmissions. For example, as noted, the mobile device may have previously received data (e.g., assistance data) with information about one of a wireless node (e.g., a node serving the cell within which the mobile device is located) indicating a particular deployment (e.g., the bandwidth configuration for the wireless node) that is normally associated with a particular reference signal pattern (including, more specifically, a particular pre-determined CRS pattern). However, depending on traffic and load conditions, the wireless node may be configured to throttle the cell-specific reference signals to, for example, reduce the CRS bandwidth (e.g., the number of resource blocks, or RB's, in a sub-frame of LTE transmission from the wireless node dedicated to cell-specific reference signals). The mobile device may not be configured for the throttled CRS configuration of the wireless node, and may therefore operate sub-optimally. Accordingly, if the mobile device 108 periodically performs measurements to determine a possible deviation from the assumed CRS pattern associated with the wireless node from which the mobile device is receiving wireless signals, at least some of the sub-optimal performance of the of the mobile device resulting from the wireless node operating in a different mode of operation than that expected, may be mitigated. Moreover, in some embodiments, if the mobile device has previously received data indicating that a particular wireless node from which it is receiving wireless transmissions is configured to operate in more than one mode, the mobile device may be configured, under those circumstances, to determine whether the wireless transmission it is receiving are configured according to one of the modes of operation that are possible for that wireless node. For example, if the mobile device received an indication that a present cell is configured in multiple modes other than the nominal mode (e.g., CRS narrow-bandwidth mode, CRSO/mixed-bandwidth mode), the mobile device may be implemented to periodically apply or run a peak-width detector (such as those described herein) to determine if current cell transmission correspond to that mode, and/or to periodically run an alias detector (as described herein) to determine if cell transmissions correspond to mixed-bandwidth mode. Additionally, if the mobile device detects another possible mode of communication (e.g., based on measurements and other operations, as described herein), the mobile device may be configured to communicate with a remote device/server to provide information indicating that a mode of operation, different from a first mode of operation the wireless node is known to be associated with, was detected. Subsequently, the remote device/server may send assistance data to other mobile devices (e.g., when such other mobile devices enter a cell with respect to which the mobile device 108 has sent the communication message indicating the possible additional modes of operations) to thus alert those entering mobile devices that the wireless node in question may operate in multiple modes of operations (such as the throttled-CRS mode of operations discussed herein). Thus, in some embodiments, the mobile device, may include a communication module (wireless transceiver) to receive one or more wireless signals transmitted from a wireless node (configured to operate in at least a first, normal, mode of operation to transmit wireless transmissions, including one or more sub-frames, configured according to a pre-determined first pattern of cell-specific reference signals (CRS) for the wireless node), and a controller (e.g., a processor), coupled to the wireless transceiver, configured to derive, based on the received one or more wireless signals, at least one resultant signal attribute indicative of an actual CRS pattern for the received one or more wireless signals, and to determine whether the at least one resultant signal attribute derived based on the received one or more wireless signals deviates from a corresponding expected at least one signal attribute associated with wireless signals including cell-specific reference signals produced according to the pre-determined first pattern of CRS.

As further illustrated in FIG. 1, the environment 100 may contain one or more different types of wireless communication systems or nodes. Such nodes include wireless access points (or WAPs) and may include LAN and/or WAN wireless transceivers, including, for example, WiFi base stations, femto cell transceivers, Bluetooth® wireless technology transceivers, cellular base stations, WiMax transceivers, etc. Thus, for example, the environment 100 may include the Local Area Network Wireless Access Points (LAN-WAPs) 106a-e that may be used for wireless voice and/or data communication with the mobile device 108. The LAN-WAPs 106a-e may also be utilized, in some embodiments, as independent sources of position data, e.g., through fingerprinting-based procedures, through implementation of multilateration-based procedures based, for example, on timing-based techniques, signal strength measurements (e.g., RSSI measurements), etc. The LAN-WAPs 106a-e can be part of a Wireless Local Area Network (WLAN), which may operate in buildings and perform communications over smaller geographic regions than a WWAN. Additionally in some embodiments, the LAN-WAPs 106a-e could also include pico or femto cells. In some embodiments, the LAN-WAPs 106a-e may be part of, for example, WiFi networks (802.11x), cellular piconets and/or femtocells, Bluetooth® wireless technology Networks, etc. The LAN-WAPs 106a-e may, for example, be part of a Qualcomm indoor positioning system (QUIPS). A QUIPS, or other such system implementations, may, in some embodiments, be configured so that a mobile device may communicate with a server that provides the device with data (such as assistance data, e.g., floor plans, AP MAC IDs, RSSI maps, etc.) for a particular floor or some other region where the mobile device is located. Although five (5) LAN-WAP's are depicted in FIG. 1, any number of such LAN-WAP's may be used, and, in some embodiments, the environment 100 may include no LAN-WAPs access points at all, or may include a single LAN-WAP.

As further illustrated, the environment 100 may also include a plurality of one or more types of the Wide Area Network Wireless Access Points (WAN-WAPs) 104a-c, which may be used for wireless voice and/or data communication, and may also serve as another source of independent information through which the mobile wireless device 108 may determine its position/location (as noted, at least one of the WAN-WAPs may be an eNodeB node). The WAN-WAPs 104a-c may be part of wide area wireless network (WWAN), which may include cellular base stations, and/or other wide area wireless systems, such as, for example, WiMAX (e.g., 802.16). A WWAN may include other known network components which are not shown in FIG. 1. Typically, each WAN-WAPs 104a-104c within the WWAN may operate from fixed positions or may be moveable, and may provide network coverage over large metropolitan and/or regional areas. Although three (3) WAN-WAPs are depicted in FIG. 1, any number of such WAN-WAPs may be used. In some embodiments, the environment 100 may include no WAN-WAPs at all, or may include a single WAN-WAP.

Communication to and from the mobile device 108 (to exchange data, provide location determination operations and services to the device 108, etc.) may be implemented, in some embodiments, using various wireless communication networks and/or technologies such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. In some embodiments, 4G networks, Long Term Evolution (“LTE”) networks, Advanced LTE networks, Ultra Mobile Broadband (UMB) networks, and all other types of cellular communications networks may also be implemented and used with the systems, methods, and other implementations described herein. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

In some embodiments, and as further depicted in FIG. 1, the mobile device 108 may also be configured to at least receive information from a Satellite Positioning System (SPS) 102a-b, which may be used as an independent source of position information for the mobile device 108. The mobile device 108 may thus include one or more dedicated SPS receivers configured to receive signals for deriving geo-location information from the SPS satellites. In embodiments in which the mobile device 108 can receive satellite signals, the mobile device may utilize a receiver (e.g., a GNSS receiver) specifically implemented for use with the SPS to extract position data from a plurality of signals transmitted by at least the SPS satellites 102a-b. Transmitted satellite signals may include, for example, signals marked with a repeating pseudo-random noise (PN) code of a set number of chips and may be located on ground based control stations, user equipment and/or space vehicles. The techniques provided herein may be applied to, or otherwise implemented, for use in various other systems, such as, e.g., Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that may be associated with, or otherwise enabled, for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals may include SPS, SPS-like, and/or other signals associated with such one or more SPS.

As further shown in FIG. 1, the system 100 may further include the server 110 (e.g., a location server, such as an Evolved Serving Mobile Location Center (E-SMLC) server, or any other type of server) configured to communicate, via a network 112 (e.g., a cellular wireless network, a WiFi network, a packet-based private or public network, such as the public Internet), or via wireless transceivers included with the server 110, with multiple network elements or nodes, and/or mobile wireless devices. For example, the server 110 may be configured to establish communication links with one or more of the WLAN nodes, such as the access points 106a-e, which may be part of the network 112, to communicate data and/or control signals to those access points, and receive data and/or control signals from the access points. Each of the access points 106a-e can, in turn, establish communication links with mobile devices located within range of the respective access points 106a-e. The server 110 may also be configured to establish communication links (directly via a wireless transceiver(s), or indirectly, via a network connection) with one or more of the WWAN nodes, such as the WWAN access points 104a-c depicted in FIG. 1 (which may also be part of the network 112), and/or to establish communication links with one or more mobile wireless devices (such as the device 108) of FIG. 1. The server 110 may also be configured to at least receive information from satellite vehicles 102a and/or 102b of a Satellite Positioning System (SPS), which may be used as an independent source of position information. In some embodiments, the server 110 may be part of, attached to, or reachable from network 112, and may communicate with the mobile wireless device 108 via the network 112. In some embodiments, the server 110 may collect data regarding the various devices of the environments 100, including data regarding modes of operations, each associated with a respective CRS pattern, as well as other node configuration information for one or more of the wireless nodes/devices of the environment 100. Assistance data, including modes of operations associated with one or more of the wireless nodes, may be communicated to one or more of the devices or nodes of the environment 100 (e.g., in response to a request from the mobile device 108, periodically at the initiative of the server 110, etc.) Assistance data communicated by the server 110 to a receiving wireless device may be used to facilitate improved communication between the receiving wireless device and the devices/nodes corresponding to the communicated assistance data.

In some embodiments, the server 110 may implement such protocols as an LTE Positioning Protocol (LPP) and/or an LTE Positioning Protocol A (LPPa) and/or the LPP Extensions (LPPe) protocol for direct communication, and to control and transfer measurements. The LPP and LPPa protocols are defined by 3GPP, and the ULP and LPPe protocols are defined by the Open Mobile Alliance (OMA). Other communication protocols that may be implemented by the server 110 may include protocols as Secure User plane Location (SUPL), User plane Location Protocol (ULP), etc.

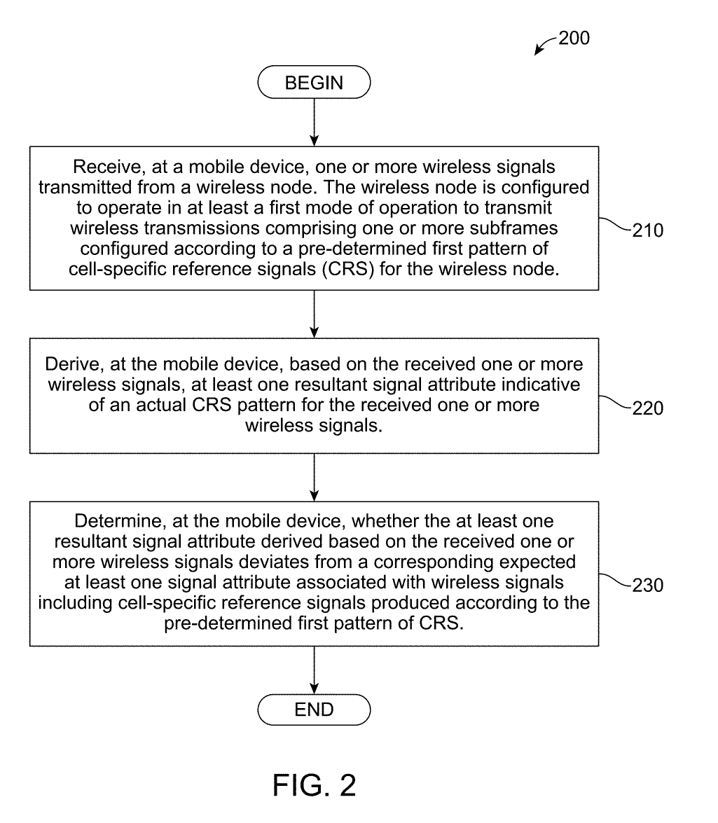

With reference now to FIG. 2, a flowchart of an example procedure 200, generally performed at a wireless mobile device (such as the mobile device 108 of FIG. 1) to detect a mode of operation for a wireless node (such as any of the nodes 104a-c and/or 106a-e depicted in FIG. 1) from which the mobile device receives wireless transmissions, is shown. The procedure 200 includes receiving 210, at a mobile device, one or more wireless signals transmitted from a wireless node (which may be configured to be an eNB node to communicate LTE-based transmissions), with the wireless node being configured to operate in at least a first mode of operation to transmit wireless transmissions comprising one or more subframes configured according to a pre-determined first pattern of cell-specific reference signals (CRS) for the wireless node. In some embodiments, other reference and/or control signaling of the wireless transmissions of the wireless node may be arranged according to some pre-determined pattern. It is also to be noted that while LTE-based transmissions are discussed as specific example embodiments of the implementations described herein, reference to LTE-based transmissions is done for illustrative purposes only. The implementations described herein may also be used with other types of communication protocols and technologies. When other types of communication technologies or protocols are used, a wireless node configured according to a different (i.e., non-LTE) communication protocol or technology may be configured to transmit reference and/or control signals according to some pre-determined pattern (as will be discussed below, a wireless device receiving communications from that wireless node may be configured to detect deviations from that pre-determined pattern of reference/control signals).

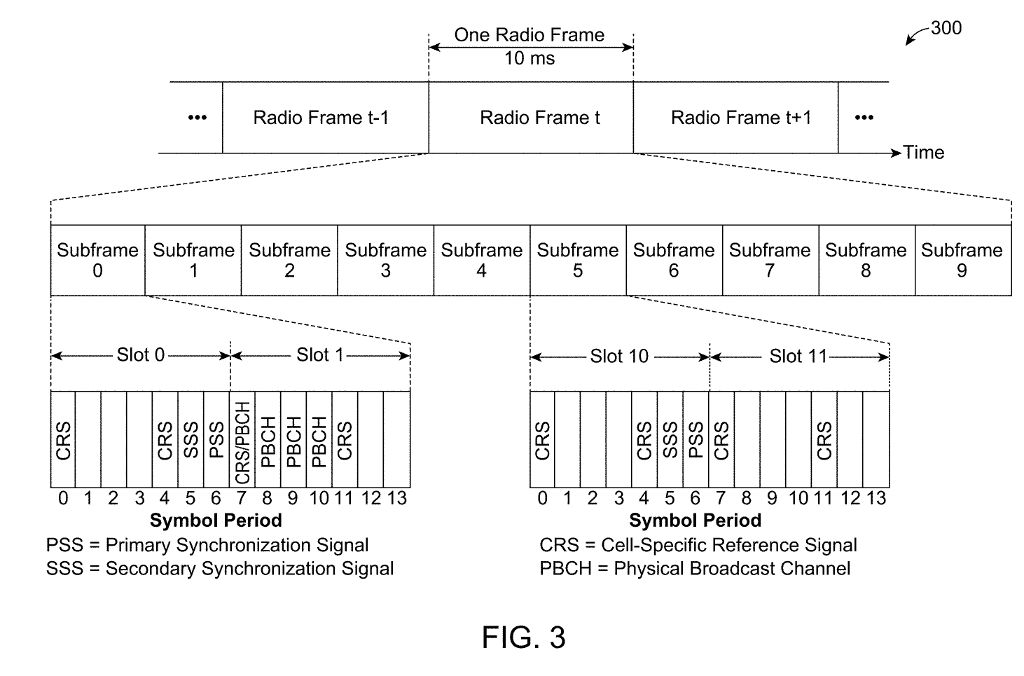

FIG. 3 is a diagram of an example frame structure 300 for downlink transmissions in LTE. The transmission timeline for the downlink may be partitioned into units of radio frames. Each radio frame may have a predetermined duration (e.g., 10 milliseconds (ms)) and may be partitioned, in some embodiments, into ten (10) subframes with indices of 0 through 9. Each subframe may include two slots (thus, a radio frame may include 20 slots with indices of 0 through 19). An eNB node may transmit various overhead channels and signals on the downlink to support communication for UEs (e.g., mobile devices such as the wireless mobile device 108 of FIG. 1). The overhead channels may include broadcast channels and/or other channels carrying system information. The overhead signals may include synchronization signals used for system/cell acquisition, reference signals used for channel quality measurements and channel estimation, and/or other signals. In LTE, an eNB node may transmit a primary synchronization signal (PSS) and a secondary synchronization signal (SSS) on the downlink in the center of the system bandwidth for each cell supported by the eNB. The PSS and SSS may be transmitted in symbol periods 6 and 5, respectively (e.g., in subframes 0 and 5 of each radio frame with the normal cyclic prefix). The PSS and SSS may be used by UEs for cell search and acquisition.

An eNB node may transmit a cell-specific reference signal (CRS) across the system bandwidth for each cell supported by the eNB. The CRS may be transmitted in certain symbols of each subframe and may be used by the UEs for channel estimation, channel quality measurement, and/or other functions. The eNB may also transmit a Physical Broadcast Channel (PBCH) in symbol periods 0 to 3 in slot 1 of subframe 0 in certain radio frames. The PBCH may carry some system information such as a Master Information Block (MIB), and may transmit other system information (such as System Information Blocks (SIBs)) on a Physical Downlink Shared Channel (PDSCH) in certain subframes. The MIB and SIBs may allow the UEs to receive transmissions on the downlink and/or send transmissions on the uplink. The PSS, SSS, CRS and PBCH in LTE are described in 3GPP TS 36.211, entitled “Evolved Universal Terrestrial Radio Access (E-UTRA); Physical Channels and Modulation,” which is publicly available. The MIB and SIBs are described in 3GPP TS 36.331, entitled “Evolved Universal Terrestrial Radio Access (E-UTRA) Radio Resource Control (RRC); Protocol specification,” which is also publicly available. As noted, in some embodiments, communication technologies and protocols other than LTE may be used, and may thus include control and reference signaling (which may be different from the control and reference signaling illustrated in FIG. 3) configured according to a some particular first pre-determined pattern.

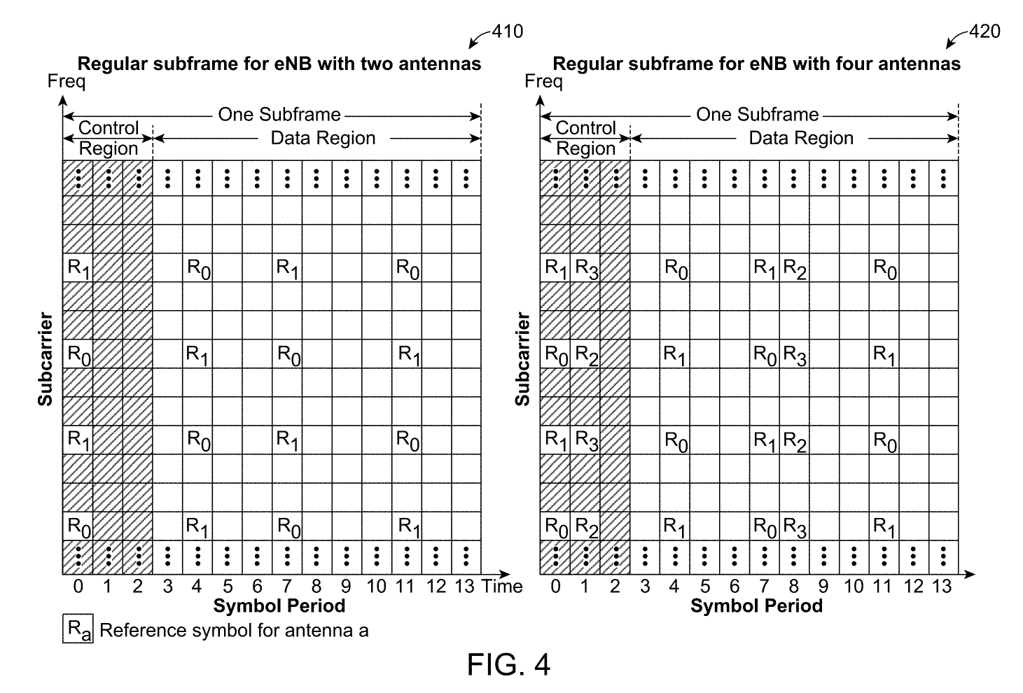

FIG. 4 is a diagram of two example subframe configurations 410 and 420 for LTE downlink transmissions. The example subframe configuration 410 corresponds to an LTE transmission from a wireless node (e.g., eNB) with two antenna ports, while the example subframe configuration 420 corresponds to an LTE transmission from a wireless node with four (4) antenna ports. Generally, the available time frequency resources for the downlink transmission are partitioned into resource blocks, with each resource block covering, in some embodiments, twelve (12) subcarriers in one slot, and may include a number of resource elements. Each resource element (RE) may cover one subcarrier in one symbol period and may be used to send one modulation symbol, which may be a real or complex value. As noted, the example subframe configuration 410 may be used for an eNB equipped with two antennas, in which case the CRS may be transmitted from antennas 0 and 1 in symbols 0, 4, 7 and 11. A reference signal is a signal that is known a priori by a transmitter and a receiver and may also be referred to as pilot. A CRS is a reference signal that is specific for a cell, e.g., generated based in part on a cell identity (ID). In FIG. 4, for a given resource element with label Ra, a modulation symbol may be transmitted on that resource element from antenna a, and no modulation symbols may be transmitted on that resource element from other antennas. The subframe configuration 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe configurations 410 and 420, resource elements not used for the CRS may be used to transmit data and/or control information.

In some embodiments, the wireless node transmitting the LTE transmission may be configured according to one of multiple possible deployments, each corresponding to respective multiple possible bandwidths (e.g., 1.4 MHz, 3 MHz, 5 MHz, 10 MHz, 15 MHz, 20 MHz, etc.). Each of these multiple possible deployments may be associated with a respective at least a first mode of operation controlling a respective number of resource blocks in every subframe of the one or more wireless signals comprising cell-specific reference signals. For example, an LTE system deployment with a bandwidth of 1.4 MHz has a different number of resource blocks dedicated to transmission of CRS signaling in its normal mode of operation (also referred to as the full-bandwidth operation) than the number of resource block dedicated for CRS transmission, in the normal mode of operation, for a 20 MHz LTE system deployment. As noted, some wireless nodes may be configured to have multiple modes of operation for a given bandwidth system deployment. For example, in addition to the normal, full-bandwidth, mode of operation, a wireless node may be configured to produce subframe transmissions with different number of reference signal components. For instance, as described herein, in order to reduce interference from neighboring cells during times when traffic is low (e.g., during night time, during weekend, etc.), the wireless node may revert to a mode of operation in which fewer resource blocks in each subframe are used for CRS signaling. An example of such reduced CRS signaling may be to configure LTE subframes to limit the number of resource blocks used for symbols 0, 4, 7, and 11 to six (such a mode of operation may be referred to as narrow-band mode). In another example, an LTE subframe may be configured so as to limit the number of resource blocks used for symbols 4, 7, and 11 to six (or some other number) while leaving the number of resource blocks at symbol 0 unchanged relative the number used in the normal mode of operation (this mode may be referred to as CRSO mode, or mixed-bandwidth mode). Because each possible system deployment (each corresponding to a different bandwidth) may be associated with a different number of CRS resource block in their respective normal (full bandwidth) mode of operation, the respective number of resource blocks for other modes of operations in each deployment may also vary relative to other deployments (i.e., the number of CRS resource blocks in narrow-band mode for a 1.4 MHz deployment will be different from the number of CRS resource block in narrow-band mode for a 20 MHz deployment).

As described herein, a wireless mobile device receiving LTE transmissions from a wireless node is implemented to determine, based on signal attribute(s) of the LTE transmissions (which vary depending on which mode of operation is being used by the wireless node) whether the measured signal attribute(s) deviates from the signal attribute(s) expected to be measured if the wireless node were transmitting in its normal mode of operation. The wireless mobile device can thus detect an indication of the mode of operation used by the wireless node from which it is receiving the wireless transmissions, and if such a new mode was not known to the mobile device, to communicate a message to a remote server to record an indication of the possibility of the new mode(s) of operation for the wireless node. Thus, with continued reference to FIG. 2, based on the received one or more wireless signals, at least one resultant signal attribute is derived 220 that is indicative of an actual CRS pattern (or a pattern for some other reference or control signaling) for the received one or more wireless signals. A determination is then made 230 whether the at least one resultant signal attribute derived based on the received one or more wireless signals deviates from a corresponding expected at least one signal attribute associated with wireless signals including cell-specific reference signals produced according to the pre-determined first pattern of CRS (e.g., by computing a difference between the resultant signal attribute and the expected signal attribute, and determining if the difference exceeds some percentage-based or absolute threshold value). In situations where the wireless node transmits wireless transmissions configured according to some other (e.g., non-LTE) communication technology or protocol, the signal attribute(s) derived by the mobile device may be indicative of an actual pattern of reference or control signaling for that other communication technology or protocol, and a determination is then made of whether the derived attribute(s) deviates from some expected signal attribute(s) associated with transmissions configured according to a particular known pattern of reference or control signaling for that other communication technology or protocol.

Various ways exist to perform measurements on received wireless signals from a particular wireless node (with respect to which a determination of that node's mode of operation is to be performed). For the purpose of illustration, only a couple of example operations to derive signal attributes for received wireless signals will be described. It will be understood, however, that other types of measurements and processes may be applied to the received wireless signals to derive signal attribute(s), based on which the mode of operation for the wireless node may be determined/detected.

More particularly, in some embodiments, deriving the at least one resultant signal attribute may include determining a correlation function, also referred to as a channel energy response (CER) function, based on the received one or more wireless signals, and deriving the at least one resultant signal attribute based on the determined CER. Generally, the CER is generated based on a correlation operation between the measured signal and a corresponding correlation reference sequence (scrambling code). In some embodiments, the CER function may be determined by transforming the received one or more wireless signals into a frequency domain representation comprising frequency vectors (e.g., through application of fast-Fourier-transform (FFT) processing to the LTE signals received by the mobile device). Subsequently, frequency-domain processing is performed on the frequency vectors. In some embodiments, such frequency-domain processing may include multiplying the measured frequency vectors with some pre-determined scrambling code (e.g., a value derived based on a cell identify associated with the wireless node), to derive resultant frequency vectors. The resultant frequency vectors are then accumulated, scaled, aligned and transformed (e.g., through application of an inverse-fast-Fourier-transform (IFFT)) to obtain a resultant time-domain channel energy response (CER).

In some embodiments, determination of whether a wireless node is operating in a mode different than its normal mode (e.g., whether the wireless node is operating, for example, in the CRS narrow-band mode) may be based on attributes and characteristics of the resultant CER function. For example, the mode of operation for a wireless node may be determined based on the width of the maximum peak of the CER function. Particularly, limiting the CRS bandwidth may produce a wider correlation peak than the nominal correlation peak that is produced in a wireless node's normal mode of operation. For example, various LTE systems' bandwidth options (i.e., deployment options) cause, or generate, sinc-shaped CERs with peak-widths that are the inverse of the LTE systems' bandwidths. In some embodiments, the maximum peak for the sinc-shaped CER function for an LTE system deployment may be approximated using a quadratic fit provided as:

y=A·x²+B·x+C

The above expression may need to be normalized by an interpolated max value for the function (i.e., y/max(y)). The normalized A-parameter for the about quadratic expression (approximating the sinc-shaped function of the maximum peak for a CER function derived from the LTE transmissions) will thus give an indication of the width of the peak. For example, Table 1, shown below, provides the various expected A-parameters for CER functions corresponding to various LTE deployments (bandwidth options).

TABLE 1

| | | | | | | |
|---|---|---|---|---|---|---|
| SysBW (MHz) | 1.4 | 3 | 5 | 10 | 15 | 20 |
| Effective BW | 1.08 | 2.7 | 4.5 | 9 | 13.5 | 18 |
| (MHz) | | | | | | |
| Null-to-null | 56.9 | 22.8 | 13.7 | 6.8 | 4.6 | 3.4 |
| peak width | | | | | | |
| A-parameter | −0.0041 | −0.0252 | −0.0688 | −0.2526 | −0.4944 | −0.7262 |
| (normalized) | | | | | | |

Thus, by measuring the incoming wireless signals from a wireless node, and deriving the A-parameter signal attribute based on those wireless signals, a determination can be made as to whether the derived A-parameter deviates from the nominal A-parameter value associated with the normal mode of operation for a wireless node transmitting LTE transmissions. For example, if the actual derived A-parameter signal attributes deviates from the expected A-parameter for the wireless node (depending on which bandwidth deployment is used) by more than some threshold amount (e.g., a percentage amount such as 1%, 2%, 5%, 10%, etc., or by some specific value amount), a determination can be made that the wireless node is operating in a different mode of operation in which more or fewer resource block are devoted/dedicated to CRS (or other reference signaling). In some embodiments, the A-parameter derived may directly identify the particular mode of operation being used by the wireless node (e.g., CRS narrowband, CRS mixed band, etc.)

In implementations in which the A-parameter determination is the signal attribute used to detect whether there is a deviation from the nominal/expected value associated with normal mode of operation for the wireless node (or even detect the mode of operation being used), the quadratic expression parameters A, B, and C may be computed from the CER output generated (based on the wireless signals) as follows:
A=(CER_early+CER late)/2−CER_Prompt
B=(CER_late−CER_early)/2
C=CER_prompt
   where CER early is the value of the tap immediately before the peak, CER_late is the value of the tap immediately after the peak, and CER_prompt is the value of the peak tap, where a tap indicates an element of the CER vector.

The normalized A-parameter, used to compare against the expected normalized A-parameter values (e.g., as provided, for example, in Table 1), is computed according:

$${A}_{norm} = \frac{A}{C - \frac{{B}^{2}}{4 \cdot A}}$$

In some embodiments, one requirement for mode-of-operation detection, based on A-parameter computation, is that the maximum peak should be above some predetermined signal-to-noise-ratio (SNR) threshold. The SNR threshold to be used may be determined based on the particular system bandwidth (i.e., the LTE system deployment) and the number of sub-frame used for integration. Additional requirements for mode-of-operation detection are that peak must not be saturated (as may be determined by application of, for example, a Rachel's saturation detector that determines if multiple taps are at the top of the numeric range), and the computed normalized A-parameter has to be a negative value.

Accordingly, in some embodiments, deriving the at least one resultant signal attribute may include determining a non-linear function approximation for a maximum peak of the determined CER function, and setting the at least one resultant signal attribute to at least one parameter representative of the non-linear function approximation for the maximum peak of the determined CER function. For example, as noted, the non-linear function approximation for the maximum peak of the determined CER function may be a quadratic expression, with the quadratic parameters of the quadratic expressions being estimated based on a channel energy response (CER) for the wireless signals from the wireless node. As noted, in some implementations, the at least one signal attribute determined may be the width of the maximum peak of the CER function (such width being representative of the number of CRS resource blocks within an LTE subframe, and thus representative of the mode of operation for the wireless node), with the maximum peak width being represented using the A-parameter of the quadratic expression representative of the maximum peak of the CER function.

Another example of a signal attribute that may be used to determine if the wireless node transmitting the wireless transmission is in a mode of operation different from its normal mode of operation is the period between peaks of a CER/correlation function derived based on the received wireless signals from the wireless node. Because loss of interleaving frequency bins will produce strong alias terms that are separated by an interval that depends on where and how many of the frequency bins have been dropped, the period between peaks of the CER function may thus be indicative of whether (and possibly which) a mode of operation different from the normal mode of operation for the wireless node is being used. Thus, in some embodiments, deriving the at least one resultant signal attribute may include determining a period between peaks (e.g., successive or non-successive peaks) of the CER function, with the period between the peaks being indicative of the actual CRS pattern for the received one or more wireless signals.

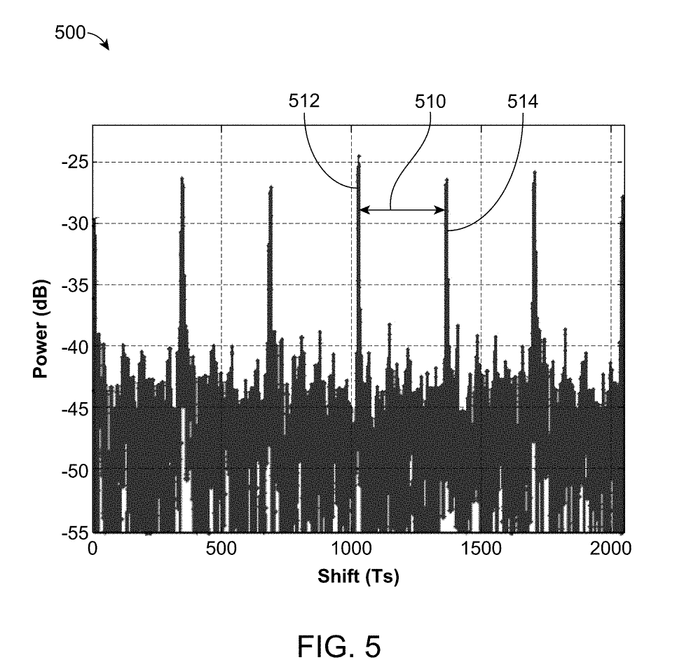

Consider, for example, FIG. 5, which includes a graph 500 showing alias terms for a CER function generated from received LTE wireless transmissions configured according to a mixed-bandwidth mode of operation (e.g., no change to the CRS resource blocks for symbol 0 of the subframe, but with symbols 4, 7, and 11 of the subframe limited to 6 CRS resource blocks). In this example, the alias terms are separated by an interval 510 (marked with respect to two successive peaks 512 and 514 of the CER function) of approximately 341 Tₛ (with Tₛ being approximately 32.6 ns, resulting in the interval/period 341 Tₛ equaling approximately 11.11 μs). In situations where full CRS bandwidth is used by the wireless node (i.e., when it is configured for its normal mode of operation), fewer alias terms are generally produced for the CER function generated from normal LTE transmissions, and accordingly, the period between peaks will be larger. Thus, measurement of the period between, for example, successive correlation peaks may be indicative of whether a mode different than the normal mode of operation for the wireless node is being used (e.g., whether the measured/derived period deviates from the normal period between peaks by some predetermined percent threshold, or by some predetermined period value) and/or what mode of operation is being used.

In some embodiments, detection of, for example, a mixed-bandwidth mode of operation may proceed as follows. For a full-length generated CER function, the tap index of the maximum peak is first identified (i.e., the location of the maximum peak in the vector, e.g., in the space of [0, 2047]).

Next, the index of the early and late 341 Ts candidates (denoted as ‘earlyIndex’ and ‘lateIndex’) is determined. For example, the CER vector is inspected to look for alias term that are approximately 341 Ts from the maximum peak. Subsequently, the maximum value within some number of taps, e.g. five (5) taps, of the early and late aliases is determined. Because of multipath effects, there may not be an alias term at exactly 341.3333 Ts distance from the maximum peak, and thus some space around the expected alias location needs to be inspected.

As noted, determination of the mode of operation used by the wireless node can be based on computation/derivation of other types of signal attributes, each of which could be indicative of the number of CRS resource blocks in LTE subframes produced by the transmitting wireless node. Therefore, by determining if there is a deviation between the derived signal attribute and the expected signal attribute value expected were the wireless node operating in its normal mode of operation (in which CRS resource blocks were included according to a pre-determined pattern associated with the node's normal mode of operation), use of another mode of operation for the wireless node can be detected (it is also possible to identify, in some embodiments, the particular mode of operation employed by the wireless node). Such detection processing can thus avoid having to test received wireless signals for different possible reference signal patterns, which may require computational-heavy processing, taken over a relatively long period of time (e.g., several frames), and instead performing a more direct measurement of the signals over a relatively shorter period of time (e.g., one or few sub-frames).

As described herein, in some embodiments, to mitigate the amount of processing required at individual mobile devices to detect/identify different modes of operations (and possible schedules) for wireless nodes (e.g., whether particular wireless nodes support different modes of operations, times at which such different modes of operation may be activated, etc.), information about the modes for wireless nodes may be collected and communicated to a central server that can maintain information collected from individual mobile devices, and provide that information (as part of assistance data messages transmitted to mobile devices). The collection and transmission of information about modes of operation corresponding to a particular wireless node may be performed as part of the mode of operation detection procedure (such as the procedure 200 of FIG. 2, as described herein), and may be realized as part of a crowd-sourcing implementation to collect information about wireless nodes configured for LTE communication. For example, information about a wireless node, including possible modes of operation that the wireless node is known, or has been observed, to employ, schedules for using those possible modes of operation, etc., may transmitted to a mobile device entering a cell served by such a wireless node (e.g., during cell detection operations performed by the entering mobile device), or in response to a request for assistance data from the mobile device. Alternatively and/or additionally, a server maintaining information about wireless nodes may transmit assistance data periodically to mobile device in a particular geographical area. Thus, in some embodiments, the mobile device may be configured to transmit to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS. Additionally, the mobile device may also be configured to receive from a remote device (e.g., a central server), maintaining assistance data relating to one or more wireless nodes, a message comprising information indicative of one or more modes of operation for the wireless node, with each of the one or more modes of operation associated with a different one of one or more CRS patterns for wireless signals from the wireless nodes. For example, if a mobile device, such as the mobile device 108 of FIG. 1, enters the service area of a wireless node (e.g., such as any of the wireless nodes 104a-c), the mobile device may request from the wireless node, or from a server (such as the server 110) associated with the wireless node, assistance data that includes information regarding possible modes of operation for the that wireless node. Alternatively and/or additionally, the remote server (via one or more of the wireless nodes with which it communicates) may initiate transmission of assistance data that includes information about the modes of operation associated with the particular wireless node.

In some embodiments, detecting the mode of operation in which a wireless node is operating may include applying different timing attributes to the received one or more wireless signals in order to aid the detection of various reference signaling included with the subframes of the wireless transmissions (e.g., CRS signaling, PRS signaling, etc.) The different timing attributes may include offset attributes representative of relative starting positions of various reference signal components (e.g., resource blocks) from a beginning of a first sub-frame, and repetition attributes representative of repetition period of reference signals in the received one or more wireless signals. Applying different timing attributes can be performed, for example, by adjusting a parameter such as I_PRS, which controls the offset and repetition timing attributes. For instance, if a reference signal pattern is detected for a particular value of I PRS, and that pattern is different from the normal reference signal pattern, this could be indicative that the transmitting wireless node supports additional modes of operation other than the normal mode of operation known to be supported by the node. Thus, in some embodiments, receiving one or more wireless signals transmitted from a wireless node may include receiving the one or more wireless signals using multiple different timing attributes applied to the received one or more wireless signals. The multiple different timing attributes applied to the one or more received wireless signals may include, for example, offset attributes representative of relative starting positions of a CRS signal from a beginning of a first sub-frame, and/or repetition attributes representative of repetition period of CRS signals in the received one or more wireless signals. Thus, in some implementations, one or more network configuration parameters may provide an indication of deployment/use of a mode of operation different from the normal mode of operation of a cell.

As noted, failure to adjust operation of a mobile device when a wireless node is communicating with the mobile device in a different mode of operation than the normal mode assumed by the mobile device may result in sub-optimal operation of the mobile device, at least for some of the mobile device's functionality. For example, for positioning functionality, in situations where a wireless node is operating in, for example, narrow-band mode (e.g., limit CRS resource block in symbols 0, 4, 7, and 11 to six RB's) and the mobile device has not detected that, the uncertainty associated with measurements of signals transmitted by the wireless node operating in the undetected narrow-band mode will be under-estimated. Thus, if a mobile device is measuring signals from a mix of cells in which some cells are operating in their normal mode and some are operating in one or their other modes of operation, the measurement uncertainty for measurements for signals operating in their non-nominal mode (e.g., narrow-band mode) will be over-weighted in a WLS (weighted-least-square) positioning solution. Effectively, there is an inverse relation between time resolution and frequency bandwidth. If the mobile device is performing positioning operation under the assumption that it is detecting/measuring a normal-mode signals (e.g., an LTE sub-frame with fifty (50) resource blocks), but in fact the mobile device is measuring signals transmitted in, for example, narrow-bandwidth mode (e.g., six resource blocks instead of fifty resource blocks), the resulting uncertainty will be under-estimated. This uncertainty under-estimation may be represented using the ratio of Cramer-Rao lower bound (CRLB) uncertainty estimates, which can be expressed according to, for example, CRLB measurement uncertainty({50 RBs, 75 RBs, 100 RBs})/CRLB_measurement uncertainty(6 RBs)={0.12, 0.08, 0.06}. Thus, for example, if the uncertainty for signals processed under the assumption that they are normal-mode (50 RBs) signals is 120 m, the measurement uncertainty in a situation where the signals are in fact transmitted in narrow-bandwidth mode would be 120/0.12=1000 m.

There are several possible solutions/ways to mitigate deficiencies resulting from positioning measurements for signals received from nodes operating in non-nominal modes of operation. One possible solution is to detect those wireless nodes/cells transmitting signals in a mode of operation other than its normal mode (detection of such wireless nodes may be performed in accordance with the procedures and other implementations described herein, and based also on assistance data that may have identified cells/nodes likely to operate in different modes of operation other than their normal mode of operation), and inflating/increasing the uncertainty associated with measurements of signals configured according to a CRS pattern associated with the different modes of operating for those detected nodes/cells. Another possible solution is to detect nodes/cells transmitting LTE signals configured according to non-nominal modes of operation, and reject (i.e., not use) those measurements coming from those non-nominally operating wireless nodes. Although this is a straightforward solution, a disadvantage of implementing this solution is that there will be a potentially large dilution of precision (DOP) impact. Yet another possible solution is to use multi-hypothesis CER processing and pick the one with the best SNR (i.e., full bandwidth mode of operation vs. matched bandwidth mode of operation). A disadvantage with this solution is the high work load required. A further solution is to detect nodes/cells transmitting LTE signals configured according to non-nominal modes of operation, and align measurements with always-full-bandwidth CRS on SIB1.

Another problem with positioning functionality in situations in which wireless nodes are operating, for example, in a mixed-bandwidth mode of operation (e.g., no change to the number of CRS resource blocks in symbol 0 of a sub-frame, and the number of CRS resource blocks in symbols 4, 7, and 11 limited to six RB's) is that if the correct mode of operation is not detected, the CER will contain 11.11 μs ambiguities instead of 22.22 μs. While ambiguity resolution for positioning functionality works will with at least a five (5) cell input when the ambiguity is that of 22.22 μs, when the ambiguity is twice that, additional cells/nodes would be required for successful ambiguity resolution. Also, because a node operating in the mixed-bandwidth mode will have lower hearability than nominal mode, fewer of those cells/nodes would be detectable. Possible solutions to mitigate this problem include detecting cells/nodes operating in the non-nominal (e.g., mixed bandwidth) mode, and not using (e.g., rejecting) signal measurements for signals from those cells/nodes. As noted above, although this approach is straightforward, it can result in a significant DOP impact. Another possible solution is to detect and conditionally reject signal measurements from nodes operating in the non-nominal mode (e.g., transmitting LTE signals configured with a mixed-bandwidth CRS pattern). The measurement from a signal determined to be configured according to the non-nominal operation mode pattern may be used/accepted if the 11.11 μs ambiguity can be resolved. This approach is considered relatively safe, and will generally result in fewer dropped cells. Two further possible solutions to mitigate the aliasing ambiguity problem caused by cells using a mixed-bandwidth mode of operation is to use multi-hypothesis CER processing and pick the hypothesis with the best SNR, and detecting aligning cells/nodes configured according to non-nominal modes of operation, aggregating information about such detected cells/nodes to a remote server, aiding the mobile device, and aligning measurements with always-full-bandwidth CRS on SIB1. These two solutions/approaches require relatively high overhead and computational effort. An additional solution is to detect and report 11.11 μs ambiguities.

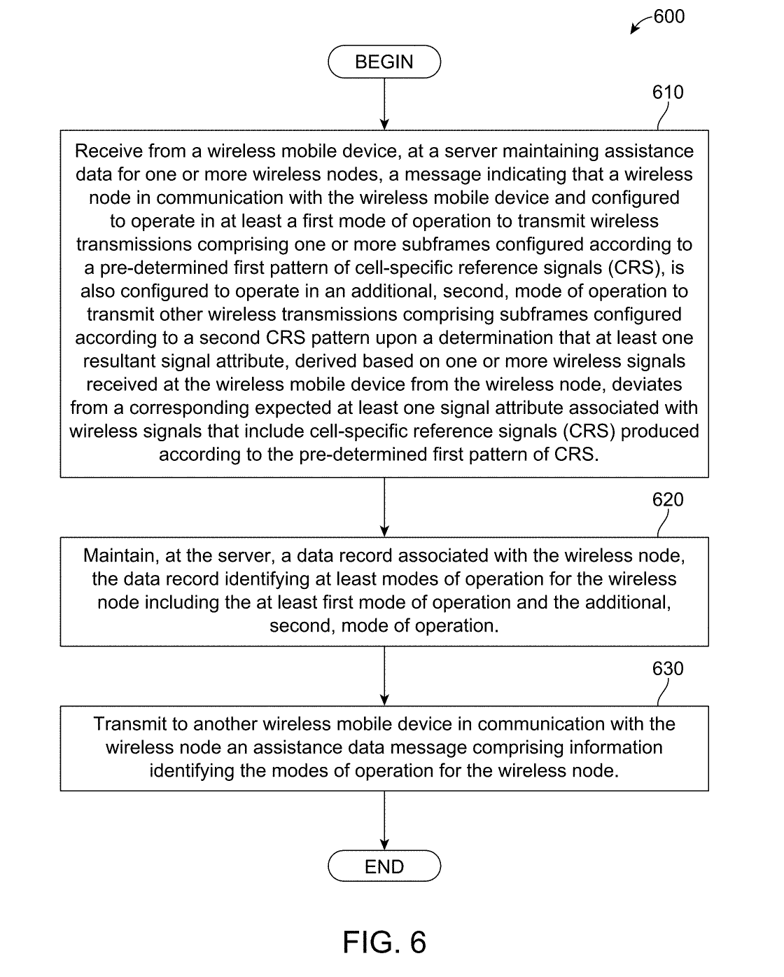

With reference to FIG. 6, a flowchart of an example procedure 600, generally performed at a server (such as the server 110 depicted in FIG. 1), to collect and manage mode-of-operation information for one or more wireless nodes (such as any of the nodes 104a-c and/or 106a-e), is shown. The procedure 600 thus includes receiving 610 from a wireless mobile device (such as the wireless mobile device 108 depicted in FIG. 1), at the server maintaining assistance data for the one or more wireless nodes, a message indicating that a wireless node in communication with the wireless mobile device and configured to operate in at least a first mode of operation to transmit wireless transmissions comprising one or more subframes configured according to a pre-determined first pattern of cell-specific reference signals (CRS), is also configured to operate in an additional, second, mode of operation to transmit other wireless transmissions comprising subframes configured according to a second CRS pattern upon a determination that at least one resultant signal attribute, derived based on one or more wireless signals received at the wireless mobile device from the wireless node, deviates from a corresponding expected at least one signal attribute associated with wireless signals that include cell-specific reference signals (CRS) produced according to the pre-determined first pattern of CRS. As noted, the wireless node may also be configured to transmit communications configured (produced) according to a pattern of other types of reference and/or control signaling, and may also be configured to transmit communication according to non-LTE technologies/protocols that include control and reference signaling configured according to some pre-determined pattern. As described herein, detection of the modes of operation for the wireless node may be performed in accordance with the operations discussed in relation to the procedure 200 of FIG. 2. The message from the wireless mobile device may be received directly from the wireless mobile device (e.g., via a wireless transceiver of the server) or indirectly via an intermediate node that is in communication with the server and the wireless mobile device.

Having received the message from the wireless mobile device, a data record associated with the wireless node is maintained 620 (e.g., created or updated) at the server (the server may be implemented as single computing system or as a collections of distributed computing systems), with the data record identifying at least modes of operation for the wireless node including the at least first mode of operation and the additional, second, mode of operation. The data record may be created, or updated, to reflect the various parameters and attributes that may be associated with the second mode of operation (including measureable and/or derivable signal attributes associated with the second mode of operation). In some embodiments, the creation or updating of a data record to reflect the additional, second, mode of operation may be performed in response to receipt, by the server, of a threshold number of messages (and/or from a threshold number of mobile devices). In such embodiments, a threshold-trigger updating can inhibit the possibility of detection of a false-positive by one or more mobile devices (i.e., to prevent the erroneous detection of non-normal mode of operation from a wireless node). However, if, for example, a sufficient number of mobile devices have detected transmissions corresponding to non-normal reference and control signaling, the corresponding transmitting wireless node may be deemed to be capable of, and/or to have been transmitting according to a non-normal pattern of reference and control signaling (e.g., CRS narrow-bandwidth or CRS mixed bandwidth for a wireless node transmitting LTE-based communications).

Subsequently, at some future time instance, an assistance data message comprising information identifying the modes of operation for the wireless node is transmitted 630 to another wireless mobile device in communication with the wireless node. The transmission of the assistance data message may be done in response to a request from the other wireless mobile device, or at the initiative of the server, which may periodically transmit broadcast messages to various wireless mobile devices (e.g., devices within a particular cell coverage) to provide these devices with assistance data regarding wireless nodes with which they may communicate.

In some embodiments, the server (maintaining the assistance data) may also be configured to monitor incoming indications, from wireless mobile devices, that particular one or more wireless nodes have switched to operating in a second mode of operation (e.g., CRS narrow-bandwidth or CRS mixed-bandwidth for LTE-type transmissions, or some other mode for a non-LTE type transmission). That is, the server may be configured to determine the detected number of occurrences of non-normal mode transmissions (e.g., in some geographical area) over some interval of time (i.e., an occurrence of non-normal mode of transmission is deemed to be detected by a mobile device if a derived signal attributes deviates from an expected signal attribute for the normal mode transmissions). If the number of indications received by the server exceeds some detection threshold value, this may confirm that the particular one or more wireless nodes are in fact operating in the non-normal mode of operation, and may thus indicate that operation conditions (communication traffic conditions, environmental conditions, etc.) are such that operating in non-normal mode of operation may be warranted for additional wireless nodes. Thus, in such embodiments, upon a determination that the number of indications, received during some pre-determined interval of time (e.g., 10 second, 1 minute, 1 hour, 1 day, etc.) of detected non-normal mode of operations (e.g., detection of transmissions configured according to a reference and control signaling pattern that is different than the one used for normal mode of operation) exceeds the detection threshold, the server may be configured to transmit control signals to at least one other wireless node (for which it may be collecting information) to cause that at least one other wireless node to switch to a similar non-normal mode of operation as the one that may have been detected for the particular one or more wireless nodes. As noted, the various wireless nodes may be configured to produce and transmit LTE transmissions (e.g., the nodes may be eNB nodes), or they may be configured to produce and transmit non-LTE transmissions.

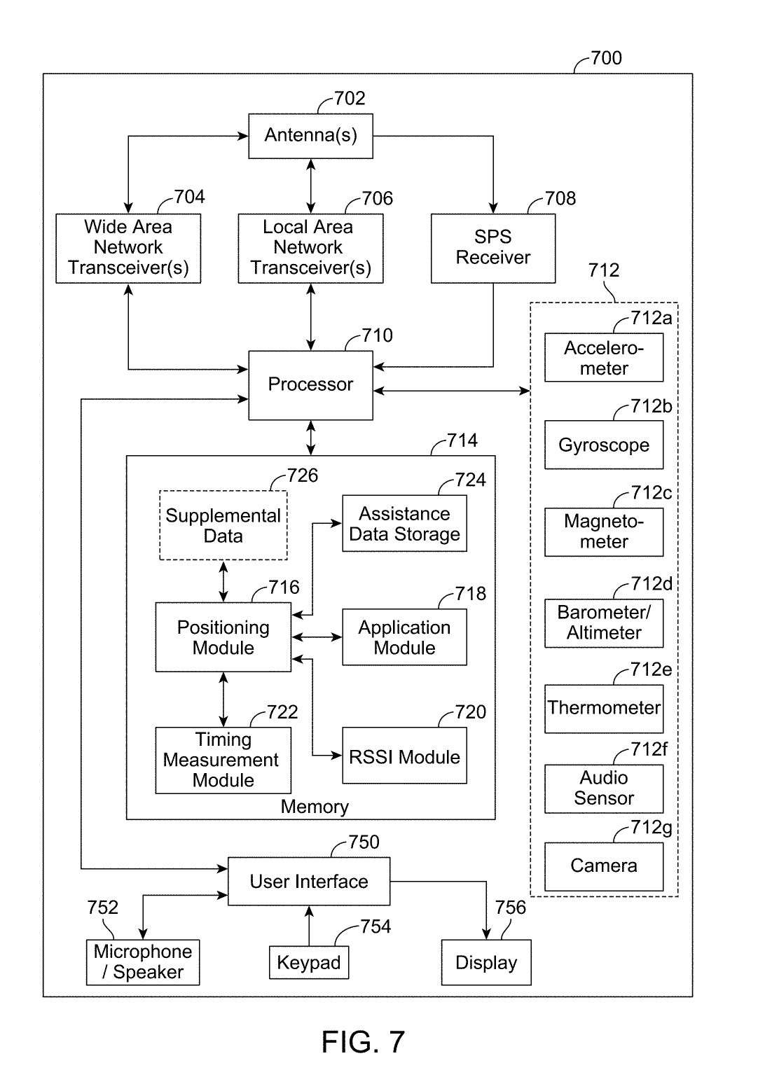

With reference now to FIG. 7, a schematic diagram illustrating various components of an example wireless device 700 (e.g., a wireless mobile device), which may be similar to or the same as the wireless devices 108 depicted in FIG. 1, is shown. For the sake of simplicity, the various features/components/functions illustrated in the schematic boxes of FIG. 7 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 7 may be further subdivided, or two or more of the features or functions illustrated in FIG. 7 may be combined. Additionally, one or more of the features or functions illustrated in FIG. 7 may be excluded. In some embodiments, some or all of the components depicted in FIG. 7 may also be used in implementations of one or more of the wireless nodes 104a-c, and/or106a-e, as well as the server 110 illustrated in FIG. 1. In such embodiments, the components depicted in FIG. 7 may be configured to cause the operations performed by devices/nodes (wireless devices/nodes, servers, etc.) as described herein (e.g., to detect modes of operation of a wireless node transmitting, for example, LTE transmissions configured to one or more CRS patterns, to maintain assistance data that includes modes-of-operation data, and so on).

As shown, the wireless device 700 may include one or more local area network transceivers 706 that may be connected to one or more antennas 702. The one or more local area network transceivers 706 comprise suitable devices, circuits, hardware, and/or software for communicating with and/or detecting signals to/from one or more of, for example, the WLAN access points 106a-e depicted in FIG. 1, and/or directly with other wireless devices (e.g., mobile devices) within a network. In some embodiments, the local area network transceiver(s) 706 may comprise a WiFi (802.11x) communication transceiver suitable for communicating with one or more wireless access points; however, in some embodiments, the local area network transceiver(s) 706 may be configured to communicate with other types of local area networks, personal area networks (e.g., Bluetooth® wireless technology networks), near-field communication devices, etc. Additionally, any other type of wireless networking technologies may be used, for example, Ultra Wide Band, ZigBee, wireless USB, etc.

The wireless device 700 may also include, in some implementations, one or more wide area network transceiver(s) 704 that may be connected to the one or more antennas 702. The wide area network transceiver 704 may comprise suitable devices, circuits, hardware, and/or software for communicating with and/or detecting signals from one or more of, for example, the WWAN nodes 104a-c illustrated in FIG. 1 (which may be eNB nodes), and/or directly with other wireless devices within a network. In some implementations, the wide area network transceiver(s) 704 may comprise a CDMA communication system suitable for communicating with a CDMA network of wireless base stations. In some implementations, the wireless communication system may comprise other types of cellular telephony networks, such as, for example, TDMA, GSM, WCDMA, LTE, etc. Additionally, any other type of wireless networking technologies may be used, including, for example, WiMax (802.16), etc.

In some embodiments, an SPS receiver (also referred to as a global navigation satellite system (GNSS) receiver) 708 may also be included with the wireless device 700. The SPS receiver 708 may be connected to the one or more antennas 702 for receiving satellite signals. The SPS receiver 708 may comprise any suitable hardware and/or software for receiving and processing SPS signals. The SPS receiver 708 may request information as appropriate from the other systems, and may perform the computations necessary to determine the position of the wireless device 700 using, in part, measurements obtained by any suitable SPS procedure. Additionally, measurement values for received satellite signals may be communicated to a location server configured to facilitate location determination.

As further illustrated in FIG. 7, the example wireless device 700 includes one or more sensors 712 coupled to a processor/controller 710. For example, the sensors 712 may include motion sensors to provide relative movement and/or orientation information (which is independent of motion data derived from signals received by the wide area network transceiver(s) 704, the local area network transceiver(s) 706, and/or the SPS receiver 708). By way of example but not limitation, the motion sensors may include an accelerometer 712a, a gyroscope 712b, and a geomagnetic (magnetometer) sensor 712c (e.g., a compass), any of which may be implemented based on micro-electro-mechanical-system (MEMS), or based on some other technology. The one or more sensors 712 may further include an altimeter (e.g., a barometric pressure altimeter) 712d, a thermometer (e.g., a thermistor) 712e, an audio sensor 712f (e.g., a microphone) and/or other sensors. The output of the one or more sensors 712 may be provided as data transmitted to a remote device or server (via the transceivers 704 and/or 706, or via some network port or interface of the device 700) for storage or further processing. As further shown in FIG. 7, in some embodiments, the one or more sensors 712 may also include a camera 712g (e.g., a charge-couple device (CCD)-type camera, a CMOS-based image sensor, etc.), which may produce still or moving images (e.g., a video sequence) that may be displayed on a user interface device, such as a display or a screen, and that may be further used to determine an ambient level of illumination and/or information related to colors and existence and levels of UV and/or infra-red illumination.

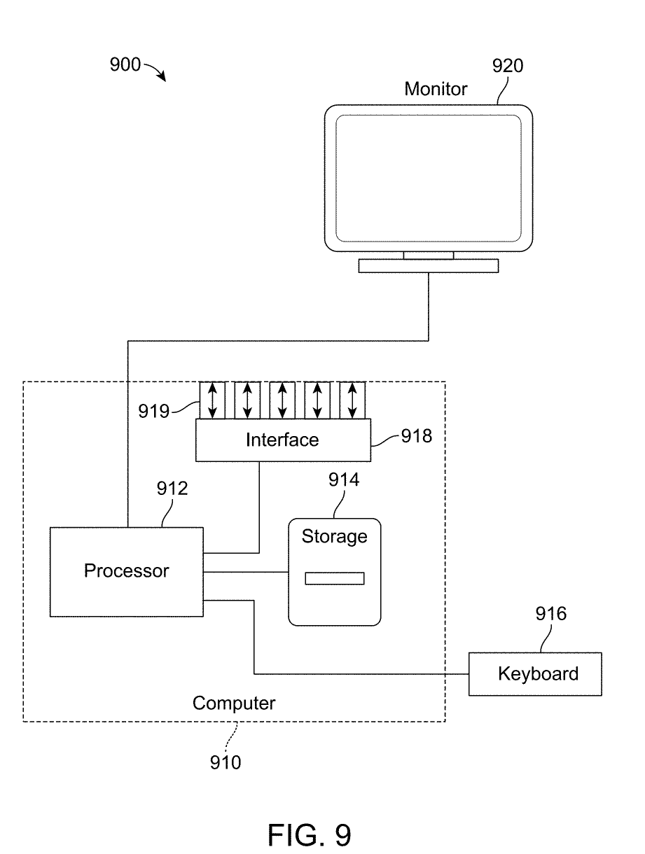

The processor(s) (also referred to as a controller) 710 may be connected to the local area network transceiver(s) 706, the wide area network transceiver(s) 704, the SPS receiver 708, and the one or more sensors 712. The processor may include one or more microprocessors, microcontrollers, and/or digital signal processors that provide processing functions, as well as other calculation and control functionality. The processor 710 may be coupled to storage media (e.g., memory) 714 for storing data and software instructions for executing programmed functionality within the mobile device. The memory 714 may be on-board the processor 710 (e.g., within the same IC package), and/or the memory may be external memory to the processor and functionally coupled over a data bus. Further details regarding an example embodiment of a processor or computation system, which may be similar to the processor 710, are provided below in relation to FIG. 9.

A number of software modules and data tables may reside in memory 714 and may be utilized by the processor 710 in order to manage both communications with remote devices/nodes (such as the various nodes and/or the server 110 depicted in FIG. 1), perform positioning determination functionality, and/or perform device control functionality. As illustrated in FIG. 7, in some embodiments, the memory 714 may include a positioning module 716, an application module 718, a received signal strength indicator (RSSI) module 720, and/or a timing measurement module 722 to measure timing information in relation to received signals. It is to be noted that the functionality of the modules and/or data structures may be combined, separated, and/or be structured in different ways depending upon the implementation of the wireless device 700. For example, the RSSI module 720 and/or the timing measurement module 722 may each be realized, at least partially, as a hardware-based implementation, and may thus include such devices or circuits as a dedicated antenna (e.g., a dedicated timing measurement and/or an RSSI antenna), a dedicated processing unit to process and analyze signals received and/or transmitted via the antenna(s) (e.g., to determine signal strength of received signals, determine timing information in relation to signals and/or an RTT cycle, etc.)

The application module 718 may be a process(es) running on the processor 710 of the wireless device 700, which requests position information from the positioning module 716, or which receives positioning/location data from a remote device (e.g., a remote location server). Applications typically run within an upper layer of the software architectures, and may include indoor navigation applications, shopping applications, location aware service applications, etc. The positioning module/circuit 716 may derive the position of the wireless device 700 using information derived from various receivers and modules of the wireless device 700, e.g., based on signal strength measurements, and/or timing measurements (including timing measurements of LTE transmissions received by the mobile device via, for example, its WWAN transceiver(s) 704). Data derived by the positioning module 716 may be used to supplement location information provided, for example, by a remote device (such as a location server) or may be used in place of location data sent by a remote device. For example, the positioning module 716 may determine a position of the device 700 (or positioning of some other remote device) based on measurements performed by various sensors, circuits, and/or modules of the wireless device 700, and use those measurements in conjunction with assistance data received from a remote server to determine location of the device 700 (the assistance data may include data regarding one or more modes of operation that the wireless node transmitting the signals received by the mobile device is configured to operate in). The memory 714 may also include a module(s) to implement the processes described herein, e.g., a process to receive wireless signals, derive at least one signal attribute indicative of a mode of operation of the wireless node transmitting the wireless signals, and determine if the derived at least one signal attribute deviates from an expected signal attribute associated with a normal/nominal mode of operation for the wireless node in which LTE transmissions are configured according to a first CRS pattern. Alternatively, the processes described herein may be implemented through the application module 718. As discussed herein, transmissions from the wireless node may be configured according to a pre-determined pattern associated with other control and reference signaling, and/or may also be configured according to some pattern of control and reference signaling for non-LTE transmissions.

As further illustrated, the wireless device 700 may also include assistance data storage 724, where assistance data (which may have been received from, for example, a server such as the server 110 of FIG. 1), such as map information, data records relating to various nodes in an area where the device is currently located (including data regarding possible modes of operation for those various nodes), heatmaps, neighbor lists, and etc., is stored. In some embodiments, the wireless device 700 may also be configured to receive supplemental information that includes auxiliary position and/or motion data which may be determined from other sources (e.g., from the one or more sensors 712). Such auxiliary position data may be incomplete or noisy, but may be useful as another source of independent information for estimating the position of the device 700, or for performing other operations or functions. Supplemental information may also include, but not be limited to, information that can be derived or based upon Bluetooth signals, beacons, RFID tags, and/or information derived from a map (e.g., receiving coordinates from a digital representation of a geographical map by, for example, a user interacting with a digital map). The supplemental information may optionally be stored in the storage module 726 schematically depicted in FIG. 7.

The wireless device 700 may further include a user interface 750 providing suitable interface systems, such as a microphone/speaker 752, a keypad 754, and a display 756 that allows user interaction with the device 700. The microphone/speaker 752 (which may be the same or different from the sensor 7120 provides for voice communication services (e.g., using the wide area network transceiver(s) 704 and/or the local area network transceiver(s) 706). The keypad 754 may comprise suitable buttons for user input. The display 756 may include a suitable display, such as, for example, a backlit LCD display, and may further include a touch screen display for additional user input modes.

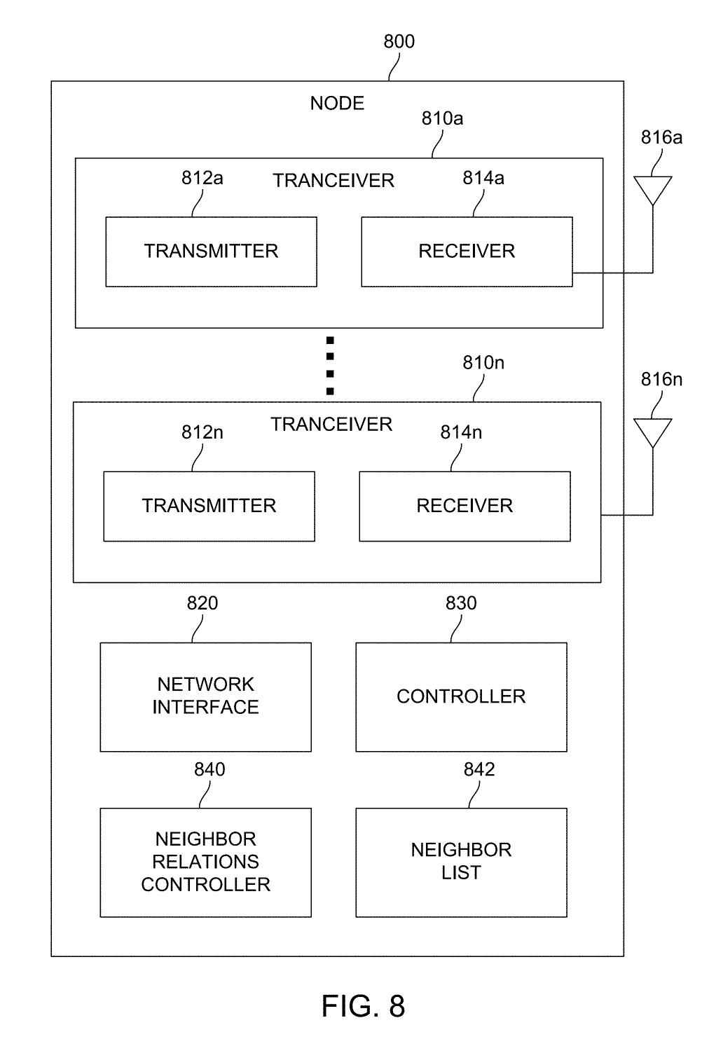

With reference now to FIG. 8, a schematic diagram of an example wireless node 800, such as access point (e.g., a base station, a server), which may be similar to, and be configured to have a functionality similar to that, of any of the various nodes depicted in FIG. 1 (e.g., the nodes 104a-c and/or 106a-e, and/or the server 110), is shown. The node 800 may include one or more transceivers 810a-n electrically coupled to one more antennas 816a-n for communicating with wireless devices, such as, for example, the wireless devices 108 or 700 of FIGS. 1 and 7, respectively. The each of the transceivers 810a-810n may include a respective transmitter 812a-n for sending signals (e.g., downlink messages) and a respective receiver 814a-n for receiving signals (e.g., uplink messages). The node 800 may also include a network interface 820 to communicate with other network nodes (e.g., sending and receiving queries and responses). For example, each network element may be configured to communicate (e.g., wired or wireless backhaul communication) with a gateway, or other suitable device of a network, to facilitate communication with one or more core network nodes (e.g., any of the other wireless nodes shown in FIG. 1, the server 110, and/or other network devices or nodes). Additionally and/or alternatively, communication with other network nodes may also be performed using the transceivers 810a-n and/or the respective antennas 816a-n.

The node 800 may also include other components that may be used with embodiments described herein. For example, the node 800 may include, in some embodiments, a controller 830 (which may be similar to the processor 710 of FIG. 7) to manage communications with other nodes (e.g., sending and receiving messages) and to provide other related functionality. For example, the controller 830 may be configured to control the operation of the antennas 816a-n so as to adjustably control the antennas' transmission power and phase, gain pattern, antenna direction (e.g., the direction at which a resultant radiation beam from the antennas 816a-n propagates), antenna diversity, and other adjustable antenna parameters for the antennas 816a-n of the node 800. In some embodiments, the antennas' configuration may be controlled according to pre-stored configuration data provided at the time of manufacture or deployment of the node 800, or according to data obtain from a remote device (such as a central server sending data representative of the antenna configuration, and other operational parameters, that are to be used for the node 800). The node 800 may also be configured, in some implementations, to perform location data services, or performs other types of services, for multiple wireless devices (clients) communicating with the node 800 (or communicating with a server coupled to the node 800), and to provide location data and/or assistance data (e.g., including modes-of-operation data related to various wireless nodes) to such multiple wireless devices. The node 800 may also be configured to transmit wireless signals produced according to various reference signal patterns (e.g., various CRS patterns) associated with different modes of operation, and to perform the various procedures and processes described herein in relation to FIGS. 1-7. The node 800 may be configured to transmit wireless signals according to LTE and/or non-LTE communication protocols and technologies.

In addition, the node 800 may include, in some embodiments, neighbor relations controllers (e.g., neighbor discovery modules) 840 to manage neighbor relations (e.g., maintaining a neighbor list 842) and to provide other related functionality. The controller 830 may be implemented, in some embodiments, as a processor-based device, with a configuration and functionality similar to that shown and described in relation to FIG. 9. In some embodiments, the node may also include one or more sensors (not shown), such as any of the one or more sensors 712 of the wireless device 700 depicted in FIG. 7.

Performing the procedures described herein may also be facilitated by a processor-based computing system. With reference to FIG. 9, a schematic diagram of an example computing system 900 is shown. The computing system 900 may be housed in, for example, a wireless device such as the devices 108 and 700 of FIGS. 1 and 7, and/ or may comprise at least part of, or all of, wireless devices, servers, nodes, access points, or base stations, such as the nodes 104a-c, 106a-e, 110, and 800 depicted in FIGS. 1 and 8. The computing system 900 includes a computing-based device 910 such as a personal computer, a specialized computing device, a controller, and so forth, that typically includes a central processor unit (CPU) 912. In addition to the CPU 912, the system includes main memory, cache memory and bus interface circuits (not shown). The computing-based device 910 may include a mass storage device 914, such as a hard drive and/or a flash drive associated with the computer system. The computing system 900 may further include a keyboard, or keypad, 916, and a monitor 920, e.g., a CRT (cathode ray tube), LCD (liquid crystal display) monitor, etc., that may be placed where a user can access them (e.g., a mobile device's screen).

The computing-based device 910 is configured to facilitate, for example, the implementation of one or more of the processes/procedures described herein, including the process to detect different modes of operation for a wireless node, and to maintain assistance data that included the modes of operations for various wireless nodes. The mass storage device 914 may thus include a computer program product that, when executed on the computing-based device 910, causes the computing-based device to perform operations to facilitate the implementation of the processes/procedures described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. For example, as illustrated in FIG. 9, the computing-based device 910 may include an interface 918 with one or more interfacing circuits (e.g., a wireless port that include transceiver circuitry, a network port with circuitry to interface with one or more network device, etc.) to provide/implement communication with remote devices (e.g., so that a wireless device, such as any of the wireless devices or nodes depicted in any of the figures, could communicate, via a port, such as the port 919, with another device or node). Alternatively and/or additionally, in some embodiments, special purpose logic circuitry, e.g., an FPGA (field programmable gate array), a DSP processor, an ASIC (application-specific integrated circuit), or other types of circuit-based and hardware arrangements may be used in the implementation of the computing system 900. Other modules that may be included with the computing-based device 910 are speakers, a sound card, a pointing device, e.g., a mouse or a trackball, by which the user can provide input to the computing system 900. The computing-based device 910 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device 910 or external to the device. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically (e.g., with lasers). Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

### Further Subject Matter/Embodiments of Interest

The following recitation is drawn to additional subject matter that may be of interest and which is also described in detail herein along with subject matter presented in the initial claims presently presented herein:

A—A method comprising: receiving from a wireless mobile device, at a server maintaining assistance data for one or more wireless nodes, a message indicating that a wireless node in communication with the wireless mobile device and configured to operate in at least a first mode of operation to transmit wireless transmissions comprising one or more subframes configured according to a pre-determined first pattern of cell-specific reference signals (CRS), is also configured to operate in an additional, second, mode of operation to transmit other wireless transmissions comprising subframes configured according to a second CRS pattern upon a determination that at least one resultant signal attribute, derived based on one or more wireless signals received at the wireless mobile device from the wireless node, deviates from a corresponding expected at least one signal attribute associated with wireless signals that include cell-specific reference signals (CRS) produced according to the pre-determined first pattern of CRS; maintaining, at the server, a data record associated with the wireless node, the data record identifying at least modes of operation for the wireless node including the at least first mode of operation and the additional, second, mode of operation; and transmitting to another wireless mobile device in communication with the wireless node an assistance data message comprising information identifying the modes of operation for the wireless node.

B—A server to maintain assistance data for one or more wireless nodes, the server comprising: a transceiver configured to: receive from a wireless mobile device a message indicating that a wireless node in communication with the wireless mobile device and configured to operate in at least a first mode of operation to transmit wireless transmissions comprising one or more subframes configured according to a pre-determined first pattern of cell-specific reference signals (CRS), is also configured to operate in an additional, second, mode of operation to transmit other wireless transmissions comprising subframes configured according to a second CRS pattern upon a determination that at least one resultant signal attribute, derived based on one or more wireless signals received at the wireless mobile device from the wireless node, deviates from a corresponding expected at least one signal attribute associated with wireless signals that include cell-specific reference signals (CRS) produced according to the pre-determined first pattern of CRS; and one or more processors, coupled to the transceiver, the one or more processors configured to: maintain a data record associated with the wireless node, the data record identifying at least modes of operation for the wireless node including the at least first mode of operation and the additional, second, mode of operation; wherein the transceiver is further configured to transmit to another wireless mobile device in communication with the wireless node an assistance data message comprising information identifying the modes of operation for the wireless node.

C—An apparatus comprising: means for receiving from a wireless mobile device, at a server maintaining assistance data for one or more wireless nodes, a message indicating that a wireless node in communication with the wireless mobile device and configured to operate in at least a first mode of operation to transmit wireless transmissions comprising one or more subframes configured according to a pre-determined first pattern of cell-specific reference signals (CRS), is also configured to operate in an additional, second, mode of operation to transmit other wireless transmissions comprising subframes configured according to a second CRS pattern upon a determination that at least one resultant signal attribute, derived based on one or more wireless signals received at the wireless mobile device from the wireless node, deviates from a corresponding expected at least one signal attribute associated with wireless signals that include cell-specific reference signals (CRS) produced according to the pre-determined first pattern of CRS; means for maintaining, at the server, a data record associated with the wireless node, the data record identifying at least modes of operation for the wireless node including the at least first mode of operation and the additional, second, mode of operation; and means for transmitting to another wireless mobile device in communication with the wireless node an assistance data message comprising information identifying the modes of operation for the wireless node.

D—A non-transitory computer-readable media programmed with instructions, executable on a processor, to: receive from a wireless mobile device, at a server maintaining assistance data for one or more wireless nodes, a message indicating that a wireless node in communication with the wireless mobile device and configured to operate in at least a first mode of operation to transmit wireless transmissions comprising one or more subframes configured according to a pre-determined first pattern of cell-specific reference signals (CRS), is also configured to operate in an additional, second, mode of operation to transmit other wireless transmissions comprising subframes configured according to a second CRS pattern upon a determination that at least one resultant signal attribute, derived based on one or more wireless signals received at the wireless mobile device from the wireless node, deviates from a corresponding expected at least one signal attribute associated with wireless signals that include cell-specific reference signals (CRS) produced according to the pre-determined first pattern of CRS; maintain, at the server, a data record associated with the wireless node, the data record identifying at least modes of operation for the wireless node including the at least first mode of operation and the additional, second, mode of operation; and transmit to another wireless mobile device in communication with the wireless node an assistance data message comprising information identifying the modes of operation for the wireless node.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

1. A method comprising:
receiving, at a mobile device, one or more wireless signals transmitted from a wireless node, wherein the wireless node is configured to operate in at least a first mode of operation to transmit wireless transmissions comprising one or more subframes configured according to a pre-determined first pattern of cell-specific reference signals (CRS) for the wireless node;
deriving, at the mobile device, based on the received one or more wireless signals, at least one resultant signal attribute indicative of an actual CRS pattern for the received one or more wireless signals; and
determining, at the mobile device, whether the at least one resultant signal attribute derived based on the received one or more wireless signals deviates from a corresponding expected at least one signal attribute associated with wireless signals including cell-specific reference signals produced according to the pre-determined first pattern of CRS.

2. The method of claim 1, further comprising:
transmitting by the mobile device to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS.

3. The method of claim 1, further comprising:
receiving from a remote device, maintaining assistance data relating to one or more wireless nodes, a message comprising information indicative of one or more modes of operation for the wireless node, each of the one or more modes of operation associated with a different one of one or more CRS patterns for respective one or more wireless transmissions from the wireless node.

4. The method of claim 1, wherein the wireless node is an evolved node B (eNB), and wherein the wireless transmissions from the wireless node are configured as long term evolution (LTE) transmissions.

5. The method of claim 1, wherein deriving the at least one resultant signal attribute comprises:
determining a channel energy response (CER) function based on the received one or more wireless signals; and
deriving the at least one resultant signal attribute based on the determined CER function.

6. The method of claim 5, wherein determining the CER function comprises:
transforming the received one or more wireless signals into a frequency domain representation comprising frequency vectors;
performing frequency-domain processing, including multiplying the frequency vectors with one or more pre-determined scrambling codes, to derive resultant frequency vectors; and
transforming the resultant frequency vectors to obtain a resultant time-domain CER function output.

7. The method of claim 5, wherein deriving the at least one resultant signal attribute comprises:
determining a non-linear function approximation for a maximum peak of the determined CER function; and
setting the at least one resultant signal attribute to at least one parameter representative of the non-linear function approximation for the maximum peak of the determined CER function.

8. The method of claim 7, wherein the non-linear function approximation for the maximum peak of the determined CER function is a quadratic expression.

9. The method of claim 5, wherein deriving the at least one resultant signal attribute comprises:
determining a period between peaks of the CER function, the period between the peaks being indicative of the actual CRS pattern for the received one or more wireless signals.

10. The method of claim 1, wherein receiving the one or more wireless signals transmitted from the wireless node comprises:
receiving the one or more wireless signals using multiple different timing attributes applied to the received one or more wireless signals.

11. The method of claim 10, wherein the multiple different timing attributes applied to the one or more received wireless signals comprise: offset attributes representative of relative starting positions of a CRS signal from a beginning of a first subframe, and repetition attributes representative of repetition period of CRS signals in the received one or more wireless signals.

12. The method of claim 1, wherein the wireless node is configured according to one of multiple possible deployments corresponding to respective multiple possible bandwidths, each of the multiple possible deployments being associated with a respective at least the first mode of operation controlling a respective number of resource blocks in every subframe of the one or more wireless signals comprising cell-specific reference signals.

13. A mobile wireless device comprising:
a transceiver configured to:
receive one or more wireless signals transmitted from a wireless node, wherein the wireless node is configured to operate in at least a first mode of operation to transmit wireless transmissions comprising one or more subframes configured according to a pre-determined first pattern of cell-specific reference signals (CRS) for the wireless node; and
one or more processors, coupled to the transceiver, configured to:
derive, based on the received one or more wireless signals, at least one resultant signal attribute indicative of an actual CRS pattern for the received one or more wireless signals; and
determine whether the at least one resultant signal attribute derived based on the received one or more wireless signals deviates from a corresponding expected at least one signal attribute associated with wireless signals including cell-specific reference signals produced according to the pre-determined first pattern of CRS.

14. The mobile wireless device of claim 13, wherein the transceiver is further configured to:
transmit to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS.

15. The mobile wireless device of claim 13, wherein the transceiver is further configured to:
receive from a remote device, maintaining assistance data relating to one or more wireless nodes, a message comprising information indicative of one or more modes of operation for the wireless node, each of the one or more modes of operation associated with a different one of one or more CRS patterns for respective one or more wireless transmissions from the wireless node.

16. The mobile wireless device of claim 13, wherein the wireless node is an evolved node B (eNB), and wherein the wireless transmissions from the wireless node are configured as long term evolution (LTE) transmissions.

17. The mobile wireless device of claim 13, wherein the one or more processors configured to derive the at least one resultant signal attribute are configured to:
determine a channel energy response (CER) function based on the received one or more wireless signals; and
derive the at least one resultant signal attribute based on the determined CER function.

18. The mobile wireless device of claim 17, wherein the one or more processors configured to determine the CER function are configured to:
transform the received one or more wireless signals into a frequency domain representation comprising frequency vectors;
perform frequency-domain processing, including to multiply the frequency vectors with one or more pre-determined scrambling codes, to derive resultant frequency vectors; and
transform the resultant frequency vectors to obtain a resultant time-domain CER function output.

19. The mobile wireless device of claim 17, wherein the one or more processors configured to derive the at least one resultant signal attribute are configured to:
determine a non-linear function approximation for a maximum peak of the determined CER function; and
set the at least one resultant signal attribute to at least one parameter representative of the non-linear function approximation for the maximum peak of the determined CER function.

20. The mobile wireless device of claim 17, wherein the one or more processors configured to derive the at least one resultant signal attribute are configured to:
determine a period between peaks of the CER function, the period between the peaks being indicative of the actual CRS pattern for the received one or more wireless signals.

21. An apparatus comprising:
means for receiving, at a mobile device, one or more wireless signals transmitted from a wireless node, wherein the wireless node is configured to operate in at least a first mode of operation to transmit wireless transmissions comprising one or more subframes configured according to a pre-determined first pattern of cell-specific reference signals (CRS) for the wireless node;
means for deriving, based on the received one or more wireless signals, at least one resultant signal attribute indicative of an actual CRS pattern for the received one or more wireless signals; and
means for determining whether the at least one resultant signal attribute derived based on the received one or more wireless signals deviates from a corresponding expected at least one signal attribute associated with wireless signals including cell-specific reference signals produced according to the pre-determined first pattern of CRS.

22. The apparatus of claim 21, further comprising:
means for transmitting by the mobile device to a remote device, maintaining assistance data relating to one or more wireless nodes, a message identifying the wireless node as configured to operate in an additional, second, mode of operation, when the derived at least one resultant signal attribute is determined to deviate from the corresponding expected at least one signal attribute associated with the wireless signals including the cell-specific reference signals produced according to the pre-determined first pattern of CRS.

23. The apparatus of claim 21, further comprising:
means for receiving from a remote device, maintaining assistance data relating to one or more wireless nodes, a message comprising information indicative of one or more modes of operation for the wireless node, each of the one or more modes of operation associated with a different one of one or more CRS patterns for respective one or more wireless transmissions from the wireless node.

24. The apparatus of claim 21, wherein the means for deriving the at least one resultant signal attribute comprises:
means for determining a channel energy response (CER) function based on the received one or more wireless signals; and
means for deriving the at least one resultant signal attribute based on the determined CER function.

25. The apparatus of claim 24, wherein the means for determining the CER function comprises:
means for transforming the received one or more wireless signals into a frequency domain representation comprising frequency vectors;
means for performing frequency-domain processing, including means for multiplying the frequency vectors with one or more pre-determined scrambling codes, to derive resultant frequency vectors; and
means for transforming the resultant frequency vectors to obtain a resultant time-domain CER function output.

26. The apparatus of claim 24, wherein the means for deriving the at least one resultant signal attribute comprises:
means for determining a non-linear function approximation for a maximum peak of the determined CER function; and
means for setting the at least one resultant signal attribute to at least one parameter representative of the non-linear function approximation for the maximum peak of the determined CER function.

27. The apparatus of claim 24, wherein the means for deriving the at least one resultant signal attribute comprises:
means for determining a period between peaks of the CER function, the period between the peaks being indicative of the actual CRS pattern for the received one or more wireless signals.

28. A non-transitory computer-readable media programmed with instructions, executable on a processor, to:
receive, at a mobile device, one or more wireless signals transmitted from a wireless node, wherein the wireless node is configured to operate in at least a first mode of operation to transmit wireless transmissions comprising one or more subframes configured according to a pre-determined first pattern of cell-specific reference signals (CRS) for the wireless node;
derive, at the mobile device, based on the received one or more wireless signals, at least one resultant signal attribute indicative of an actual CRS pattern for the received one or more wireless signals; and
determine, at the mobile device, whether the at least one resultant signal attribute derived based on the received one or more wireless signals deviates from a corresponding expected at least one signal attribute associated with wireless signals including cell-specific reference signals produced according to the pre-determined first pattern of CRS.

29. The non-transitory computer-readable media of claim 28, wherein the instructions to derive the at least one resultant signal attribute comprise one or more instructions to:
determine a channel energy response (CER) function based on the received one or more wireless signals; and
derive the at least one resultant signal attribute based on the determined CER function.

30. The non-transitory computer-readable media of claim 29, wherein the one or more instructions to determine the CER function comprise instructions to:
transform the received one or more wireless signals into a frequency domain representation comprising frequency vectors;
perform frequency-domain processing, including multiplying the frequency vectors with one or more pre-determined scrambling codes, to derive resultant frequency vectors; and
transform the resultant frequency vectors to obtain a resultant time-domain CER function output.
